(19) United States
(12) Patent Application Publication
(10) Pub. No.: US 2021/0286486 A1
(43) Pub. Date: Sep. 16, 2021

(54) TAGGING AND AUTOMATIC RETRIEVAL OF COMMUNICATION ASSETS

(71) Applicant: Avaya Management L.P., Santa Clara, CA (US)

(72) Inventor: Sudhir Shelke, Pune (IN)

(21) Appl. No.: 16/815,934

(22) Filed: Mar. 11, 2020

(51) Int. Cl. G06F 3/0484; G06Q 10/10; G06F 3/0481

(52) U.S. Cl. CPC G06F 3/0484; G06F 3/0481; G06Q 10/109

(57) ABSTRACT

Managing digital assets (e.g., documents, link, teleconference screenshots, etc.) is a substantial burden for many users and organizations. Being able to identify assets and then retrieve the assets at a relevant time can be of critical importance. As described herein, being able to encounter and tag assets with a user name or a meeting identifier, at a first time, and then when the meeting and/or communication with the user occurs, at a later time, automatically presenting indicia of the tags to facilitate presentation of the assets may significantly improve communications and efficiency that would otherwise be spent manually marking assets and/or identifying their location for retrieval.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communication management and particularly to identification and retrieval of communication assets.

### BACKGROUND

In the prior art, a user engaged in a conversation (e.g., meeting, teleconference, instant message (IM) exchange, etc.) and wants to refer to a document, the user needs to have previously made a note of the document to be referenced. Then, assuming the user remembers to review the note, manually access and open or attach the document to the conversation. Similarly, if the user is attending a teleconference and, during the teleconference, finds useful information to share with specific contact, then the user has to download the contents onto his or her own system and thereafter follow the same manual steps of sharing the document during a subsequent conversation with those contacts.

In the case of a teleconference, a user may capture slides or snapshots being displayed, such as a shared desktop, application, or whiteboard being presented in a teleconference. Another user would who would like to view the snapshots would first need to know that they exist and then request the user who captured the images to send a copy. The user who captured the images must then locate the image and manual attach the image of the snapshot to a conference or email to be shared with the other user.

### SUMMARY

The prior art is limited to a user's tagging of assets manually and for the creation of certain assets, such as screenshots of a teleconference, for storage on a local device or other location determined at the discretion of the user performing the capture. Managing such assets may require additional manual steps, such as making manual notes of such assets, creating folders to hold the assets and/or providing a particular file name to the asset. Sharing the assets with others requires knowledge that the assets exist and then manually providing the asset, a copy of the asset, or the location of the asset to others—often encapsulated in a message, such as an email, which must also be manually created.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are disclosed wherein a digital asset, which may be referred to herein more simply as an “asset” or “assets” may be tagged with an identifier. The identifier may be an indicia of a meeting and/or indicia of an entity, such as entry in a directory comprising individuals, groups, entities, etc. or indicia of an entry (e.g., the displayed name, number, department, etc. for an entry). Upon the occurrence of the identifier, such as the start or particular portion of the meeting beginning or a communication with the entity, automatically presenting indicia of the asset(s) (e.g., icon, title, screenshot, etc.) which may be selected to cause the asset to be presented.

In another embodiment, assets created during a first teleconference, which may include a conference call, screensharing session, electronic whiteboard session, electronic conference, etc., may be created for storage as a shared asset, such as when created by the teleconferencing application for storage as an asset for the teleconference. As a benefit, users joining late or reviewing the details after the meeting are both aware of the existence of the assets and able to access the asset maintained in the accessible location.

The embodiments herein allow a user to tag offline/online contents/documents as assets with specific contacts and/or teleconference identifiers and automatically, upon the subsequent occurrence of the teleconference identified or communication with the entity identified, receive the asset or indicia of the assets for subsequent selection to enable automatic retrieval for presentation of the asset. The presentation may be limited to only the user that created the tag or shared to other participants of the teleconferences, without manual input.

Tagging is variously embodied. In one embodiment a processor causes a display to present a menu item associated with tagging an asset. Further embodiments include, presenting a tagging option upon a particular input to an input component (e.g., right click on a mouse, keystroke, drop down item selection, etc.) to a file system menu. Additionally or alternatively, an application (e.g., presentation application, web browser, document creator/viewer, spreadsheet creator/viewer, etc.) may present the asset therein and provide an icon, menu item, and/or other means by which the asset may be tagged.

As an example, a manager needs do appraisal/salary discussions with all team members. He/She can open documents of revised salary (Promotion letters etc.) from company portal and tag documents with appropriate contact ID of team members directly from portal. Whenever the meeting begins with each individual, He/She can directly check from contact list which was tagged/associated document & it can share it directly without email.

In another example, a committee member is reviewing a document and does some search in their stored contents and/or through web portal (i.e., online) and find some relevant reference material. The user may tag those contents with the contacts name, email, handle, or other identifier. As a result, a copy or link will be created to the reference material and the document will be associated with the contacts associated with document. When a subsequent communication, such as an instant message (IM), teleconference, peer-to-peer (P2P) or other electronic communication occurs, the associated documents or indicia of the documents will be displayed. When indicia of the document is displayed, selecting the indicia causes the document to be presented.

In another example, a site engineer thinks a particular document might help to test team during customer setup replication. The site engineer tags the document to associate the lead of the test team for automatic presentation during a subsequent IM conversation.

Similarly, if a user is attending a web conference where the user is interested in sharing one of the slides contents in his/her future conversations with other contacts, then the user can tag such slide online on the server to specific contact. In a further embodiment, the user can take permissions from the Author/Host to share such slides during future conversations with specific contacts.

In a further embodiment, the presentation of an asset or indicia of an asset may be accompanied by the entity (e.g., person, business, etc.) of the tag. In another embodiment, an entity, such as displayed in a directory or contact list, may be presented with a dynamically generated list of all associated assets, other entities also tagged with the same asset, and/or future meetings that will include entities that have associated tags.

The embodiments herein may comprise online and/or offline assets and may made available on a shared resource (e.g., server, storage device, etc.) so as to be available on multiple devices/locations.

In another embodiment, a server, such as a conferencing server presenting a teleconference, may be utilized to create snapshots or slides, collectively referred to herein as screenshots, for common access. The screenshots may be associated with a virtual meeting room, session identifier, or other indicia of the teleconference. The screenshots may be made available during or after the meeting with the same participants or, if authorized, different participants. The server may be configured to only give access to certain devices, such as those associated with a presenter of content in the teleconference or a moderator of the teleconference.

In another embodiment, a recurring meeting may have slides appended under the same meeting identifier and may be further configured to automatically clean-up (e.g., delete, mark for deletion, etc.) the screenshots upon the passage of a predetermined number of meetings, period of time, or calendar event (e.g., “product release date,” “deadline to submit presentation” etc.). However, an authorized party, such as a presenter or moderator may override default deletion rules to cause content to be deleted sooner, later, or not at all either individually, or by assigning an importance value which, in turn, has deletion rules or exclusions associated with the importance value (e.g., “high”=never delete, “low”=delete within three days, etc.). Importance rules may be automatically modified as well. For example, an asset scheduled to be deleted may get the deletion date extended upon a subsequent reference, such as by being accessed or when associated with another teleconference, entity, etc. Additionally or alternatively, screenshots may be captured automatically as well as in response to an input on an input device.

In one example, a manager conducts a weekly meeting with his team. Whiteboard slides are automatically created by a processor of the conference server and saved on the server or on a storage device associated with the server. A subsequent review of prior slides is available to resolve any confusion that may have occurred in a prior meeting. The slides being available on the server and accessible to all authorized parties, such as by referencing the meeting (e.g., the weekly recurring meeting, meeting with the virtual room identifier ‘1234’, etc.) or a particular instance of the meeting (e.g., the weekly meeting, the meeting with virtual room identifier and instance ‘1234-03,’ two weeks prior).

As introduced above, the server may automatically create screenshots of the slides and/or other content. This may be done on a time-base (e.g., capture a screenshot every ten seconds) or upon the content of the teleconference changing. For example, a new audio content (e.g., change in speaking party, occurrence of a keyword/phrase) may cause the server to capture an image of the teleconference. In another example, new visual content (e.g., change in presented materials, camera change to a different speaker/teleconference site, etc.) may trigger a screenshot being captured. Screenshots may be indexed serially and/or by meeting/agenda/presenter, etc. so that “next” or “previous” screenshots may be identified and, if desired, accessed.

In one embodiment, a system is disclosed, comprising: a processor, wherein the processor comprises one or more microprocessors; a data storage, wherein the data storage comprises a non-transitory physical component; a display; an input component; and wherein the processor executes machine-readable instructions to cause the processor to: cause the display to present a graphical representation of an asset; receive, via the input component, an input to tag the asset; in response to the input to tag the asset, cause the display to present an option to receive an identifier associated with an event scheduled to occur in the future; and upon the occurrence of the event, automatically presenting indicia of the asset.

In another embodiment, a method is disclosed, comprising: presenting, on a display, a graphical representation of an asset; receiving, via an input component, an input to tag the asset; in response to the input to tag the asset, causing the display to present an option to receive an identifier associated with an event scheduled to occur in the future; and upon the occurrence of the event, automatically presenting indicia of the asset.

In another embodiment, a system is disclosed, comprising: means to cause a display to present a graphical representation of an asset; means to receive, via an input component, an input to tag the asset; means to, in response to the input to tag the asset, cause the display to present an option to receive an identifier associated with an event scheduled to occur in the future; and means to, upon the occurrence of the event, automatically presenting indicia of the asset.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first display with tagging on a system in accordance with embodiments of the present disclosure;

FIG. 2 depicts a second display with tagging on a system in accordance with embodiments of the present disclosure;

FIG. 3 depicts a third display with tagging on a system in accordance with embodiments of the present disclosure;

FIG. 4 depicts a fourth display with tagged assets on a system in accordance with embodiments of the present disclosure;

FIG. 5 depicts a teleconferencing application on a system in accordance with embodiments of the present disclosure;

FIG. 6 depicts a data structure in accordance with embodiments of the present disclosure;

FIG. 7 depicts a process in accordance with embodiments of the present disclosure; and

FIG. 8 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

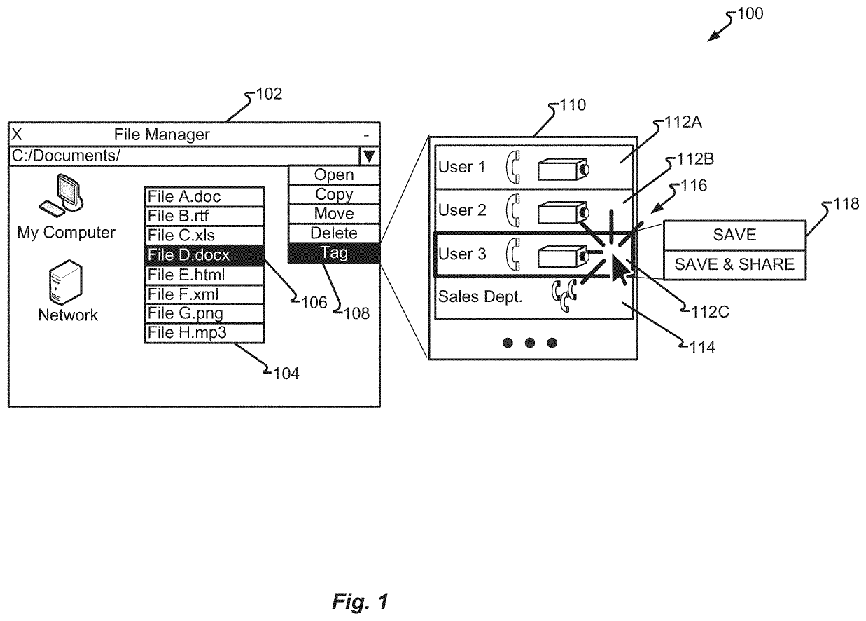

FIG. 1 depicts display 100 with tagging on a system in accordance with embodiments of the present disclosure. Display 100 illustrates visual embodiments of a tagging system presented on a display in response to at least one microprocessor which may be embodied as a processing chip, blade, core, appliance, array, distributed processing fabric (“cloud”), a plurality of a heterogeneous mix of the foregoing, a plurality of a homogeneous mix of the foregoing, or more simply put, “processor”, of the system executing machine-readable instructions and/or receiving signals from an input device (e.g., mouse, keyboard, track pad, touchscreen, etc.) of the system or in communication with the system. Generally, and in one embodiment, a user of the system tags a digital asset (or more simply put, “asset”). An asset may be one or more of a file (e.g., document, spreadsheet, presentation, media file, etc.), location (e.g., URL, network address, physical address, etc.), or other computer-readable data. Tagging, as used herein, associates the asset with an event. The event may be a next teleconference with a participant. Accordingly, a tag may associate a participant for a future teleconference or other electronic communication, including any one or more of the following: voice-only call, voice/video call, screen-sharing session, co-browsing session, instant message (IM) session, email, or other communication form via a network. An event may be a particular communication scheduled in the future (e.g., the next weekly staff meeting, the particular weekly staff meeting that will occur in three weeks, the next call with both Alice and Bob, the first instant message with either Carl or Diane, agenda item “four” of the department meeting, etc.). Additionally or alternative, an event may be triggered by the occurrence of a communication and a non-time certain event (e.g., the next call with Alice following the next product update release, etc.). It should be appreciated that the term “meeting,” as used herein, does not prohibit in-person attendees, however, there will always be at least two participants each utilizing an associated communication device in communication via a network.

In one embodiment, display 100 presents file manager window 102 comprising file listing 104. One or more files are selected (shown as highlighted), such as selected file 106 and drop-down list presents option “Tag” 108. In response to option “Tag” 108 being selected, such as by mouse-over, mouse click, right mouse button, and/or other input device signal as may be determined by the operating system and/or circuitry of the system; contact list 110 is presented comprising individuals 112A-112C. It should be appreciated that contact list 110 comprises at least one contact, but may comprise a multitude of entries arranged in alphabetical order, order of last contact, structured order (e.g., departments in a division, groups in a department, individuals in a group, etc.), or other order. In another embodiment, group 114 is provided, such as a department or other group of contacts.

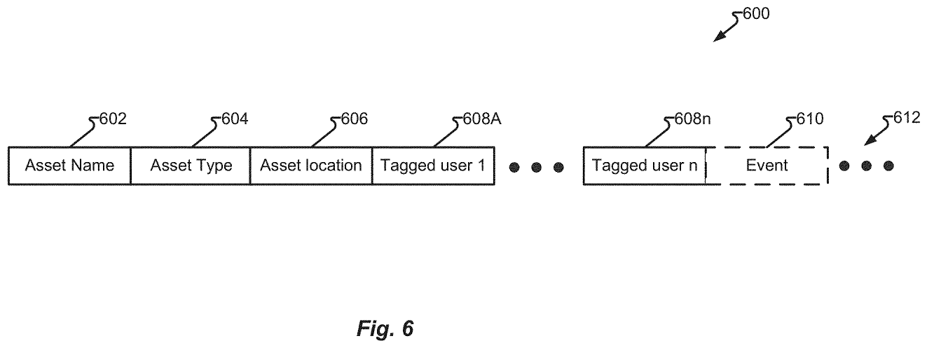

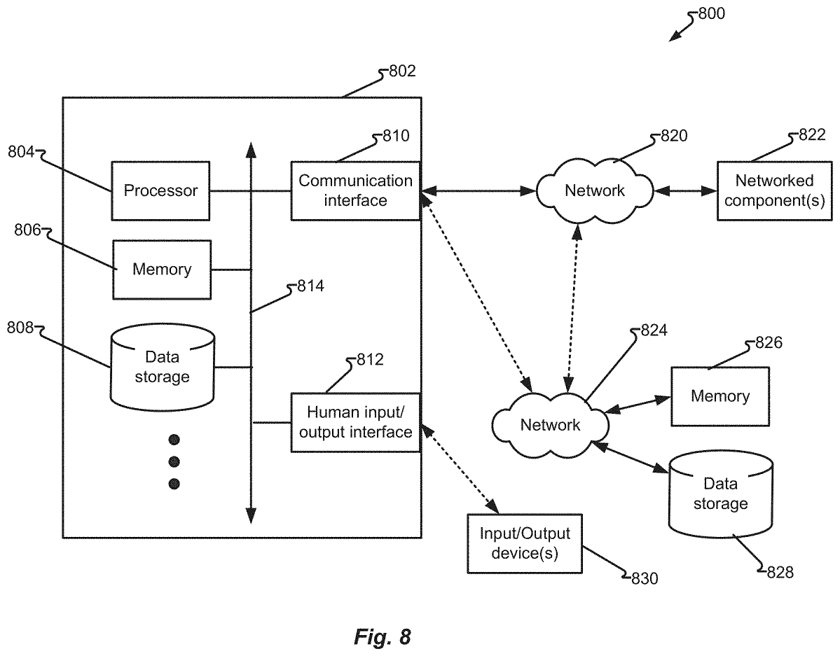

Selecting a particular contact, such as via mouse click 116 upon individual 112C, the processor associates or “tags” selected file 106 and individual 112C and/or vice versa. As a further option, dialog 118 may be presented to save the tag, thereby presenting indicia of the tagged item (e.g., selected file 106) upon the occurrence of the event, or “save and share,” to further cause the tagged item to be sent to the selected user (e.g., individual 112C). Tagging, comprises the creating or modifying of a data structure, as will be discussed more completely with respect to data structure 600 (see FIG. 6) for storage in a non-transitory data storage, which is discussed more completely with respect to memory and data storage components of system 800 (see FIG. 8).

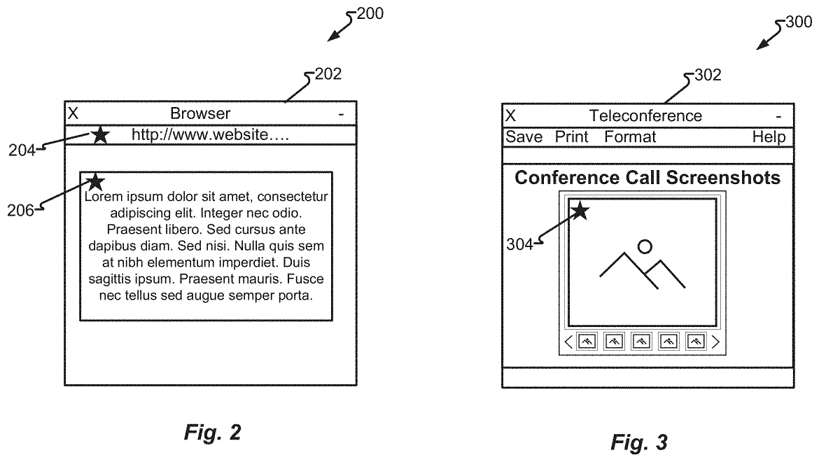

FIG. 2 depicts display 200 with tagging on a system in accordance with embodiments of the present disclosure. Display 200 presents browser application 202. In one embodiment, an indicia of tagging 204 is provided to prompt a particular website address to a user. Additionally or alternatively, indicia of tagging 206 is provided to prompt a particular portion of a website. The portion may be a page, section, image, audio file, video file, etc.

As described with respect to FIG. 1 (above), an input upon indicia of tagging 204 or indicia of tagging 206 may then bring up contact list 110 to receive a selection of an event or particular contact to be subject to the tag.

FIG. 3 depicts display 300 with tagging on a system in accordance with embodiments of the present disclosure. In another embodiment, display 300 presents teleconferencing application 302. In one embodiment, an indicia of tagging 304 is provided capture a screenshot of the teleconferencing application and they content provided (e.g., presented content, images of participant(s), etc.) in a live teleconference or in playback of a prior teleconference. The feature to capture a screenshot image is provided by the teleconferencing application, as opposed to the “print screen” function available on many personal computers.

Additionally or alternatively, images captured may be maintained on a common data storage, such as a storage device associated with the conference server or other storage device available to all the participants in the conferencing system. The conferencing server executing the teleconferencing application may provide management of the screenshot images to retrieve particular images, advance/revert to a next/previous image, etc.

The screenshot images may be stored in index order, so that a next screenshot happens later in time, which may be another instance of the same recurring teleconferencing meeting. For example, a sales department weekly meeting may index all screenshot images for common access for each of the meetings. Additionally or alternatively, screenshot images that are determined to have expired may be deleted from the data storage. Expiration may be based on time or event (e.g., purge weekly meeting screenshots at the end of the fiscal year, keep screenshot images for three months but not longer, purge images that have not been subsequently accessed for two months, etc.).

As described with respect to FIG. 1 (above), an input upon indicia of tagging 304 may then bring up contact list 110 to receive a selection of an event or particular contact to be subject to the tag. In another embodiment, tagging is automatically provided to tag the participants in the teleconference. In a further embodiment, default tagging may be overridden to add non-participants and/or delete one or more participants.

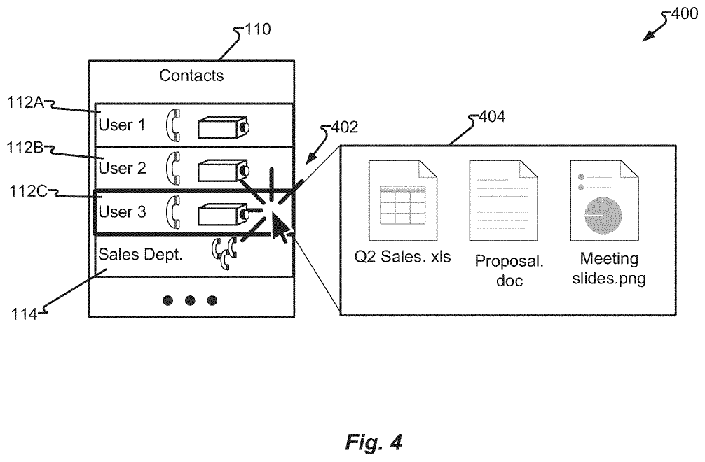

FIG. 4 depicts display 400 with tagged assets on a system in accordance with embodiments of the present disclosure. In one embodiment, the system presents contact list 110 with individuals 112A-C, group 114, and/or other contacts, including those that may not be presently visible but may be made visible, such as by scrolling or paging through the list of contacts. A selection of a contact, such as individual 112C (as illustrated by mouse click 402) may bring up tagged asset list 404. As a result, the user may initiate a communication with the selected contact (e.g., individual 112C) and have access to the tagged assets illustrated by indicia of the tagged assets (e.g., icon, file name, user description, etc.). An input to the tagged asset indicia may then cause the tagged asset to be presented on display 400 and/or sent to the contact. In another embodiment, asset list 404 allows for the indicia of tagged assets to be edited, to add or remove tagged assets therefrom.

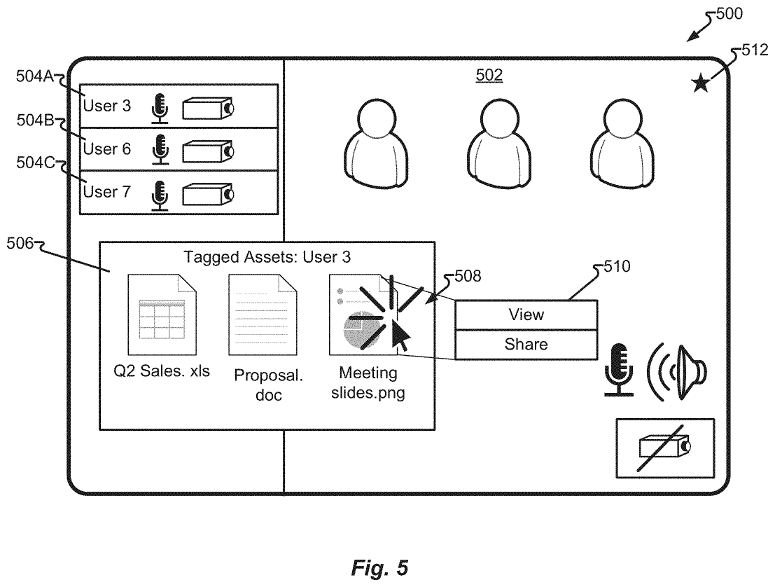

FIG. 5 depicts display 500 on a system in accordance with embodiments of the present disclosure. In one embodiment, teleconferencing application 502 is presenting an ongoing teleconference. A teleconference is one example of a communication. Teleconferencing application 500 receives conferencing content from a conferencing server (not shown) which may be a discrete application running on a server or other computer or integrated into teleconferencing application 500 or the teleconferencing application utilized by another participant (e.g., a host or moderator).

Teleconferencing application 502 may graphically, textually, or otherwise present indicia of the participants of the teleconference, such as individuals 504A-504C. In response to having previously tagged assets to a user now engaged in the teleconference, tagged asset list 506 is displayed presenting indicia of the previously tagged assets. Selecting one of the indicia of a tagged asset, such as by mouse click 508, the associated asset may be displayed. Additionally or alternatively, selecting a tagged asset (e.g., via mouse click 508) may bring up options 510, such as to view the associated asset locally and/or share the tagged asset with one or more of the participants in the teleconference. As a further option, selecting indicia of tagging 512 may capture a screenshot of the conference for indexing and storing on a storage device for subsequent access by the participants of the teleconference. Individuals and/or groups may further be associated with the tagged, such as to be presented as a tagged asset in a subsequent communication with the same or different participants.

FIG. 6 depicts data structure 600 in accordance with embodiments of the present disclosure. In one embodiment, a processor presenting, on a display, an asset or indicia of an asset may receive an input to tag the asset with a user and/or event and, in response, create data structure 600. Data structure 600 may be modified or populated if already created. Once created (or modified), the processor may then cause data structure 600 to be maintained in a data storage.

In one embodiment, data structure 600 comprises asset name field 602, which may be a user or system provided name provided for ready human understanding (e.g., “competitor's website,” “Q3 sales”, etc.). In other embodiments, data structure 600 may include asset type 604 to identify the type of asset, such as document, spreadsheet, presentation, etc. Asset type 604 may be utilized by a processor executing machine-readable instructions to select an appropriate icon or other identifier of the asset type, such as to then present the selected icon as an indicia of the asset. Additionally or alternatively, asset type 604 may comprise an icon of the type (e.g., a spreadsheet icon, a website icon, etc.) or an address identifying such an image. In certain embodiments, asset type 604 may be omitted, such as when the operating system provides a system icon, file name, or other indicia. In another embodiment, asset location 606 comprises an address, file location, URL, or other identifier of the asset, such that a subsequent selection of the indicia of the asset may retrieve the asset for viewing or transmission to others.

Tagged users 608A-608n identifies one or more users, individuals or groups, that are to be associated with the tagged asset. Then, when an event occurs, such as a subsequent communication with one or more of the users tagged, at least the contents of asset name 602 may be presented. Event 610 may be omitted, such as when the event is a default event (e.g., the next communication with at least one of tagged users 608A-608n) or further specified. For example, event 610 may specify a particular time-event or non-time certain event that, by itself or in conjunction with a subsequent communication with one or more of tagged users 608A-608n, causes indicia of the asset, such as an icon stored in or accessed from an address of, asset type 604. The asset, from asset location 606, may then be retrieved for automatic presentation and/or automatic transmission to one or more of tagged users 608A-608n. Additional or alternative, such as to add user or application specific fields, aggregate or otherwise combine fields, or other combination to provide, at least, the data storage described herein and optionally additional fields as illustrated by ellipses 612.

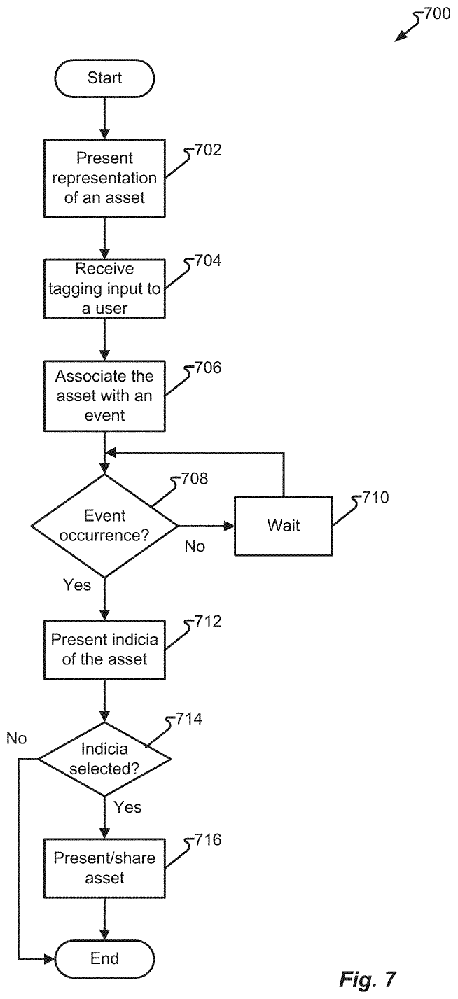

FIG. 7 depicts process 700 in accordance with embodiments of the present disclosure. Process 700 may be embodied as an algorithm encoded (e.g., compiled, interpreted, linked, etc.) into machine-readable and executable instructions by a processor. It is worth reiterating that processor may comprise one or more microprocessors and, in particular, the steps of process 700 may be executed by one or more such microprocessors. In one embodiment, process 700 begins with the presentation of an asset in step 702. The asset being presented on a display in response to signals provided by a processor. The asset may be the asset itself, as presented, or the presentation of an indicia of the asset (e.g., file name, icon, thumbnail, etc.). In step 704, an input component provides a signal associated with tagging the asset to the processor. In response, the processor associates the asset with an event. The event may be a default event, such as receiving indicia of a contact wherein the event is the next communication (via a network) with the contact. The event may comprise a time event, such as up the occurrence of a communication (e.g., the next team conference call, the department teleconference, etc.), or a combination thereof, in step 706. Step 706 then causes a data record, such as data structure 600, to be maintained in a data storage.

A processes monitors a system for the occurrence of the event in test 708 and, upon the occurrence thereof, determined in the affirmative. This may be the occurrence of the time, a communication with a tagged contact, or combination thereof. Additionally or alternatively, test 708 may the receipt of a notification that the event has occurred, such as from a communication device or application indicating that a communication with a tagged user has been initiated or is underway; clock/calendar application indicating that a time event has occurred; meeting agenda manager indicating that a particular portion of a meeting via a network has occurred or is about to occur within a previously determined timeframe; or other notifications. When such a notification comprises the event, test 708 is determined in the affirmative. If test 708 is determined in the negative, step 710 may be executed wherein a delay process is executed, such as to conserve processor and/or other resources until such time as the event occurs, wherein test 708 is re-evaluated or otherwise wait for appropriate notification.

Upon test 708 being determined in the affirmative, step 712 to present or cause to present indicia of the asset (e.g., such as may be determined by asset type 604, see FIG. 6). Test 714 determines if an input signal is received and, if determined in the affirmative, step 716 presents and/or shares the asset with one or more tagged users. Sharing may comprise transmitting “in the blind” where receipt by the destination device associated with the one or more tagged users is expected but may not occur, such as due to the receiving device being powered off, disconnected from a network, or other issue. If test 714 is determined in the negative, process 700 may loop back to test 714 until such time as test 714 is determined in the affirmative, which may comprise a delay step (e.g., wait step 710) or process 700 may terminate.

As can be appreciated, process 700 is provided for the tagging of one asset for the subsequent presentation of indicia of the asset and display/sharing thereof. However, more than one asset may be tagged and more than one event may be monitored and processed to have the associated asset indicia presented without departing from the scope of the embodiments herein.

FIG. 8 depicts device 802 in system 800 in accordance with embodiments of the present disclosure. In one embodiment, a displayed content, such as display 100, 200, 300, 400, 500 presenting teleconferencing application 502, and/or executing process 700 may be embodied, in whole or in part, as device 802 or a portion thereof, such as human input/output interface 812 of system 802 and comprising various components and connections to other components and/or systems. The components are variously embodied and may comprise processor 804. Processor 804 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), such as received via bus 814, executes instructions, and outputs data, again such as via bus 814.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, etc. In another embodiment, communication interface 810 may comprise, or be comprised by, human input/output interface 812. Communication interface 810 may be configured to communicate directly with a networked component or utilize one or more networks, such as network 820 and/or network 824.

Network 820 may be a wired network (e.g., Ethernet), wireless (e.g., WiFi, Bluetooth, cellular, etc.) network, or combination thereof and enable device 802 to communicate with network component(s) 822.

Additionally or alternatively, one or more other networks may be utilized. For example, network 824 may represent a second network, which may facilitate communication with components utilized by device 802. For example, network 824 may be an internal network to a subset of network devices, whereby components are trusted (or at least more so) that networked components 822, which may be connected to network 820 comprising a public network (e.g., Internet) that may not be as trusted. Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and allow device 802, and/or other devices, to access data thereon. Data storage 828 may comprise a repository for the storage of screenshots, such as to enable access by participants of a teleconference. Similarly, input/output device(s) 830 may be accessed by processor 804 via human input/output interface 812 and/or via communication interface 810 either directly, via network 824, via network 820 alone (not shown), or via networks 824 and 820.

It should be appreciated that computer readable data may be sent, received, stored, processed, and presented by a variety of components. It should also be appreciated that components illustrated may control other components, whether illustrated herein or otherwise. For example, one input/output device 830 may be a router, switch, port, or other communication component such that a particular output of processor 804 enables (or disables) input/output device 830, which may be associated with network 820 and/or network 824, to allow (or disallow) communications between two or more nodes on network 820 and/or network 824. Ones of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein on one or more microprocessors.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
a processor, wherein the processor comprises one or more microprocessors;
a data storage, wherein the data storage comprises a non-transitory physical component;
a display;
an input component; and
wherein the processor executes machine-readable instructions to cause the processor to:
cause the display to present a graphical representation of an asset;
receive, via the input component, an input to tag the asset;
in response to the input to tag the asset, cause the display to present an option to receive an identifier associated with an event occurring in the future; and
upon the occurrence of the event, automatically presenting indicia of the asset wherein the event comprises a communication with a party identified by the tag.

2. The system of claim 1, wherein the identifier comprises an indicia of an entry in a directory and, upon the occurrence of the event, wherein the party identified by the tag comprises a participant identified by the indicia of the entry in the directory, presenting indicia of the asset.

3. The system of claim 2, wherein the indicia of an entry in the directory comprises one or more of a thumbnail image, photograph, file name, file type, icon, text description, or animation.

4. The system of claim 1, wherein indicia of the asset comprises one or more of a thumbnail image, photograph, file name, file type, icon, text description, or animation.

5. The system of claim 1, wherein the asset comprises at least one of a document, a media file, a link, a web page, a file location address, a calendar entry, a directory entry, a geographic map location, or a portion thereof.

6. The system of claim 1, wherein the processor further causes the display to present an indicia of the tag associated with the asset and, upon receiving an input associated with the indicia of the tag via the input component, receives the input to tag the asset.

7. The system of claim 6, wherein the indicia of the tag comprises a file system option.

8. The system of claim 6, wherein the indicia of the tag comprises an application option of an application presenting the graphical representation of the asset.

9. The system of claim 1, wherein the processor further receives an input, via the input component, upon the indicia of the asset and, in response thereto, causes the display to present the asset.

10. The system of claim 1, wherein the asset comprises a screenshot.

11. The system of claim 1, wherein the asset comprises a captured image obtained by an application presenting a teleconference.

12. The system of claim 10, wherein the screenshot is maintained in the data storage comprising a storage location determined by the application and accessible to a plurality of participants of the teleconference.

13. A method, comprising:
presenting, on a display, a graphical representation of an asset;
receiving, via an input component, an input to tag the asset;
in response to the input to tag the asset, causing the display to present an option to receive an identifier associated with an event scheduled to occur in the future; and
upon the occurrence of the event that has not yet occurred and wherein the event comprises a communication with a party identified by the tag; and
upon the recurrence of the event, automatically presenting indicia of the asset.

14. The method of claim 13, wherein the identifier comprises an indicia of an entry in a directory and, upon the occurrence of the event, wherein the party identified by the tag comprises a participant identified by the indicia of the entry in the directory, presenting indicia of the asset.

15. The method of claim 14, wherein the indicia of an entry in the directory comprises one or more of a thumbnail image, photograph, file name, file type, icon, text description, or animation.

16. The method of claim 13, wherein indicia of the asset comprises one or more of a thumbnail image, photograph, file name, file type, icon, text description, or animation.

17. The method of claim 13, wherein the asset comprises at least one of a document, a media file, a link, a web page, a file location address, a calendar entry, a directory entry, a geographic map location, or a portion thereof.

18. The method of claim 13, further comprising:
presenting, on the display, an indicia of the tag; and
performs the receiving the input to tag the asset, upon receiving an input associated with the indicia of the tag.

19. The method of claim 13, wherein:
the asset comprises a screenshot captured by an application presenting a teleconference; and
the screenshot is maintained in the data storage comprising a storage location determined by the application and accessible to a plurality of participants of the teleconference.

20. A system, comprising:
means to cause a display to present a graphical representation of an asset;
means to receive, via an input component, an input to tag the asset;
means to, in response to the input to tag the asset, cause the display to present an option to receive an identifier associated with an event that has not yet occurred; and
means to, upon the occurrence of the event, automatically presenting indicia of the asset wherein the event comprises a communication with a party identified by the tag.
